(19) United States
(12) Patent Application Publication
(10) Pub. No.: US 2007/0054514 A1
(43) Pub. Date: Mar. 8, 2007

(54) SOCKET MEASUREMENT APPARATUS AND METHOD

(75) Inventors: David C. Long, Wappingers Falls, NY (US); Paul F. Bodenweber, Kingston, NY (US); Jason S. Miller, Poughkeepsie, NY (US); Yuet-Ying Yu, Hopewell Junction, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/162,173

(22) Filed: Aug. 31, 2005

(51) Int. Cl. H01R 12/00

(52) U.S. Cl. 439/70

(57) ABSTRACT

An apparatus and method to determine the amount of misalignment between a chip carrier and socket by the use of an inspection master. The inspection master is tailored to the perimeter size of the chip carrier and contains alignment marks on the same array as the electrical contact pads of the chip carrier. The inspection master allows bad sockets to be screened out prior to use on a chip carrier and also provides a quantified characterization of the socket array positional error which can be used to adjust the socket fabrication process.

### BACKGROUND OF THE INVENTION

The present invention is directed to electronic packaging, and more particularly, to socket interconnections.

Many servers, personal computers, and consumer electronics devices utilize field-replaceable microchip modules incorporating reusable Land Grid Array (LGA) sockets with high positional accuracy electrical contacts and accurate module centering features. The term LGA refers to a design option used by device manufacturers to package their devices without any terminations, such as solder balls or pins, on the bottom of the chip carrier substrate. In order for the chip carrier to electrically connect to a circuit board the LGA socket provides the intermediate contact. This LGA contact is mechanically pressed by the socket against the chip carrier contact pad which would otherwise have a solder ball, pin or some other interconnect to a circuit board.

The LGA socket contact is typically a metal spring or “fuzz button” connector. A fuzz button is commonly manufactured from a single strand of wire and compressed into a cylindrical shaped bundle. The LGA contacts are assembled into a custom molded contact carrier configured to the geometry and pitch of the chip carrier contact pad array. In other words, the socket contact array will have the same positions and pitch (center to center spacing) as the chip carrier and circuit board contact pads. In this way the socket contacts provide the electrical contact between the chip carrier and the circuit board.

The LGA socket also has a frame with some edge centering mechanism to center the chip carrier with respect to the socket contacts. This alignment is critical for good contact between the socket contacts and chip carrier contact pads, and the operation of the socket. The edge centering mechanisms are typically a spring device located on each edge of the socket frame and contacting each edge of the chip carrier. Other edge centering mechanisms are also used which contact only one or two reference edges. Whichever scheme is used the alignment relies on referencing off the edge of the chip carrier.

LGA sockets are typically used in high-end applications such as the chip carrier substrate-to-circuit board attachment of high input-output (I/O) count packages. A high I/O count package will contain chip carriers with many contact pads. This larger contact area array creates increased alignment problems between the contact array of the socket and the contact pad array of the chip carrier. The chip carrier substrate size will have an allowable perimeter size tolerance. There may also be some variation in the chip carrier contact pad pitch over the entire array. A typical square or rectangular chip carrier substrate can vary in horizontal and vertical edge size (“XY size”) by approximately plus or minus 0.008 inches for a 2 inch part and still be within allowable manufacturing specifications.

Adding to this misalignment tolerance are variations in the spacing of the LGA contact array. The molded plastic contact carrier can exhibit non-uniform contact spacing caused by manufacturing process variations such as flow variations during the molding fabrication process. If the chip carrier contact pads and the socket contacts are not aligned properly this can result in electrical opens or electrical shorts. The problem is more serious in high power applications where contact of the wrong chip carrier pad to socket contact may result in a blown connection and ruined device. Depending on the particular module there could also be damage to the circuit chip or circuit board.

The need for highly accurate and reusable LGA sockets is particularly high in the area of microchip module testing and speed sorting. In order to ensure accurate electrical test results, it is necessary to first verify socket contact positions and module centering effectiveness. While contact positional location can be verified using traditional optical measurement tools, verification of the effectiveness of module centering is not readily achievable using traditional techniques.

Therefore, there exists a need to be able to verify the positional accuracy of the electrical contacts with respect to the module as located in the socket under normal operating conditions.

Thus, a purpose of the present invention is to provide an apparatus and method to determine if a given LAG socket will have good alignment with the chip carrier to be tested prior to the actual testing.

Another purpose of the present invention is to provide an apparatus and method to characterize any positional distortion or error in a socket in order to correct subsequent socket fabrications.

These and other purposes of the present invention will become more apparent after referring to the following description considered in conjunction with the accompanying drawings.

### BRIEF SUMMARY OF THE INVENTION

The present invention discloses a socket measurement apparatus comprising a block having inspection target features located on an array, the array matching a socket electrical design contact array, and the block having a perimeter size tailored to a chip carrier perimeter size to be socket tested. The socket measurement apparatus perimeter size may be tailored to a nominal chip carrier perimeter size, a minimum chip carrier perimeter size, or a maximum chip carrier perimeter size.

The socket measurement apparatus may be an opaque block with through hole inspection target features. In a preferred embodiment the socket measurement apparatus is a transparent block with inspection target features such as a point geometry, a circular geometry, a cross geometry, and a square geometry. The transparent block is preferably made from lexan, Plexiglas, glass, quartz, acrylic, Lucite or crystal polystyrene.

The present invention also discloses a method for determining the amount of positional error in a socket; comprising the steps of providing a socket having an electrical contact array; the socket having edge centering means; providing a transparent block having inspection target features located on an array; the array matching the socket electrical contact array design nominal; inserting the transparent block in the socket; comparing the position of the inspection target features to the position of the electrical contact array, thereby determining the amount of positional error in the socket electrical contact array.

The invention also discloses a method for determining characteristics of a socket to correct socket positional error. The method includes comparing the position of the inspection target features to the position of the electrical contact array, thereby determining the magnitude and location of positional error in the socket electrical contact array; and generating an analysis of the positional error for correcting the positional error. The analysis could be used to repair a defective socket, or to adjust the socket fabrication process.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a view of a conventional LGA socket.

FIG. 2 is a view of a conventional socket assembly between a chip carrier and circuit board.

FIG. 3 is a view of an inspection master.

FIG. 4 illustrates good alignment between a socket and inspection master.

FIG. 5 illustrate poor alignment between a socket and inspection master.

### DETAILED DESCRIPTION OF THE INVENTION

The purposes of the present invention have been achieved by providing, according to the present invention, an apparatus and method for measuring LGA socket positional accuracy with respect to the socket's locating features. What is disclosed is a transparent, dimensionally equivalent replica of the chip carrier module. The replica, referred to as an “inspection master”, has precision-located features that match the LGA pad pattern of the microchip module to be socket tested. The inspection master is used by placing it in the socket that is to be tested and optically measuring the concentricity of the inspection master pattern with respect to the LGA socket contact positions. This concentricity measurement may be used to quantify and characterize the positional accuracy of the socket under actual “module insertion” conditions, taking into account both the contact positional accuracy and the module centering features of the socket.

In one embodiment of the present invention, the inspection master is fabricated from lexan plastic. Other preferred materials for fabrication of the inspection master include Plexiglas, glass, quartz, acrylic, Lucite and crystal polystyrene. The inspection master is precision machined to the precise dimensions of a nominal ceramic substrate. In this embodiment alignment marks, the inspection target features, are “dots” with a diameter of 0.006 inches. The dots were created on the inspection master with a precision drill, with each dot located concentric with the chip carrier contact pad of a nominal substrate. Other methods to create the inspection target features include, but are not limited to, a scribe, scoring, impressions by stamping, etching, chrome deposition, photo emulsion and printing.

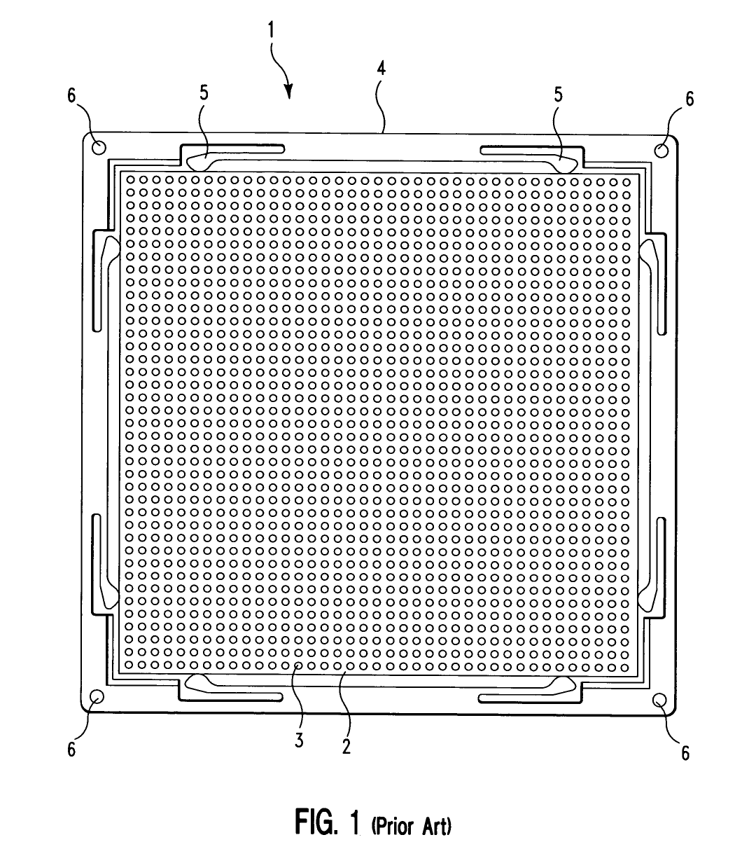

Referring to FIG. 1 there is shown a conventional LGA socket 1 comprising a socket contact carrier 2, socket electrical contacts 3, socket frame 4 and spring fingers 5. The LGA socket 1 will typically have locating pins 6 to correspond with holes in a circuit board that align the socket 1 with contact pads on the circuit board. The socket contact carrier 2 is typically designed to a 1 mm feature to feature spacing or pitch. The electrical contacts may be “C” shaped metal springs, fuzz buttons, conductive rubber buttons, or other contact types. The socket frame 4 is typically plastic but could be metal or other material.

In this example the spring fingers 5 are cantilever type springs. They contact the edge of the substrate and are typically molded as part of the socket frame or machined out of the socket frame. The present invention would be applicable to this or any alternate centering means such as metal, plastic or rubber springs. The purpose of the spring fingers 5 is to center the substrate over the contact array of the socket contact carrier 2.

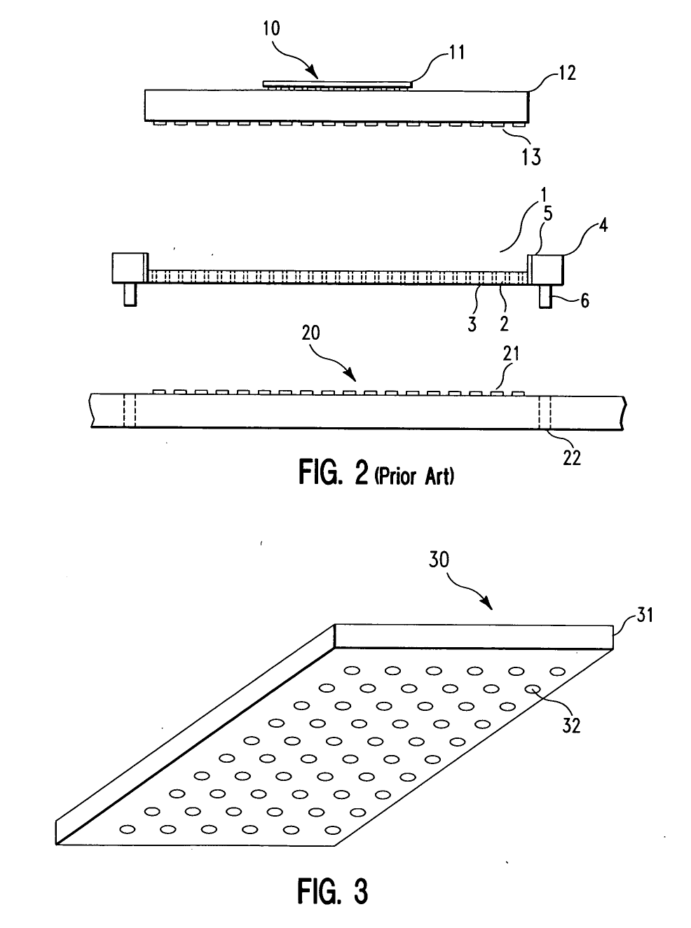

Referring to FIG. 2 there is shown a conventional electronic module 10 comprising a circuit chip 11 attached to a chip carrier 12. The chip carrier 12 will have internal conductive wiring to connect the circuit chip 11 to electrical contact pads 13 on the opposite side of the chip carrier 12. These electrical contact pads 13 are formed in an array and will need to align with and contact the socket electrical contacts 3 on the LGA socket 1. Circuit board 20 has contact pads 21 which will also align and contact with the socket electrical contacts 3 on the LGA socket 1. The circuit board 20 typically has holes 22 which align with locating pins 6 on the socket 1 to position the socket electrical contacts 3 with the circuit board contact pads 21.

Referring now to FIG. 3 there is shown the inspection master 30. The inspection master 30 is comprised of a block 31 having inspection target features 32. In a preferred embodiment the block 31 is a transparent block. However the present invention would also be applicable to a solid, non-transparent block where the alignment features are through holes in the block. The block may be square, rectangular, or any perimeter shape necessary to match the perimeter shape of the chip carrier 11 to be socket tested. The block 31 may have a variety of perimeter sizes corresponding to the nominal, minimum or maximum chip carrier 12 size.

In the preferred embodiment the inspection master 30 is a transparent replica of the chip carrier 12. The transparent block 31 has inspection target features 32 that allow optical inspection of the alignment of the LGA socket 1 and the alignment of the socket electrical contacts 3 with the inspection target features 32. The inspection target features 32 can be a variety of shapes such as a point dot, circle, square, cross, concentric rings or other convenient feature. The typical LGA socket tolerance specification on a 1 mm array of contacts is plus or minus 0.005 inches from the design center. In contrast, the inspection target features 32 on the inspection master 30 can be placed with array accuracies of better than plus or minus 0.0005 inches from the design center.

The inspection master 30, when placed in the LGA socket connector 1, will be “centered” by the spring fingers 5. In a preferred embodiment the inspection master 30 can be made in 3 sizes, corresponding to the nominal, minimum and maximum perimeter size of the applicable chip carrier. The nominal chip carrier size allows characterization of the socket for the positional error in the average case. The minimum chip carrier size would be used to determine if the spring fingers 5 have sufficient travel and spring rate to cause the minimum size chip carrier to be “centered” in the socket. This allows centering of the chip carrier in the socket at the lower limit of the specification. The maximum size inspection master 30 would be used to determine if the LGA socket 1 can accommodate the largest size chip carrier. This allows centering the chip carrier in the socket at the upper limit of the specification.

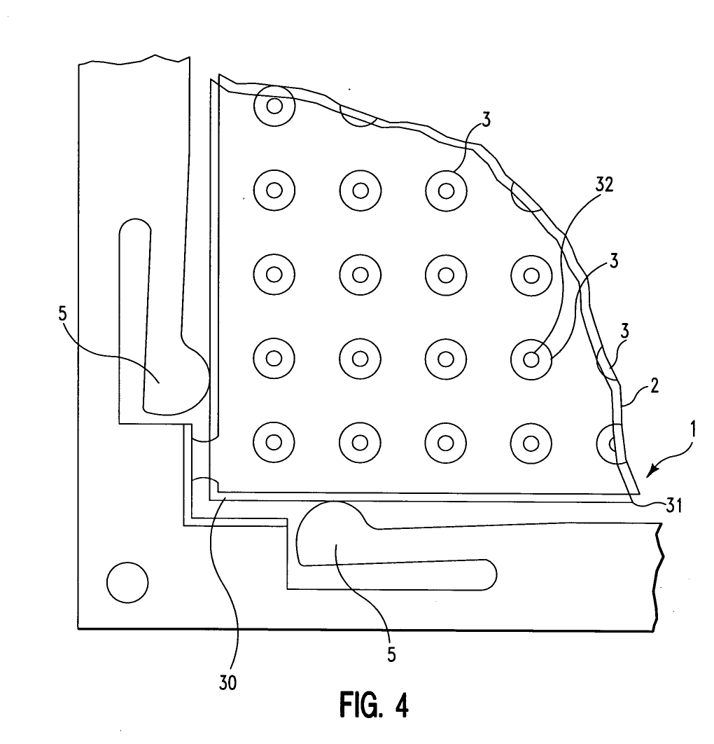

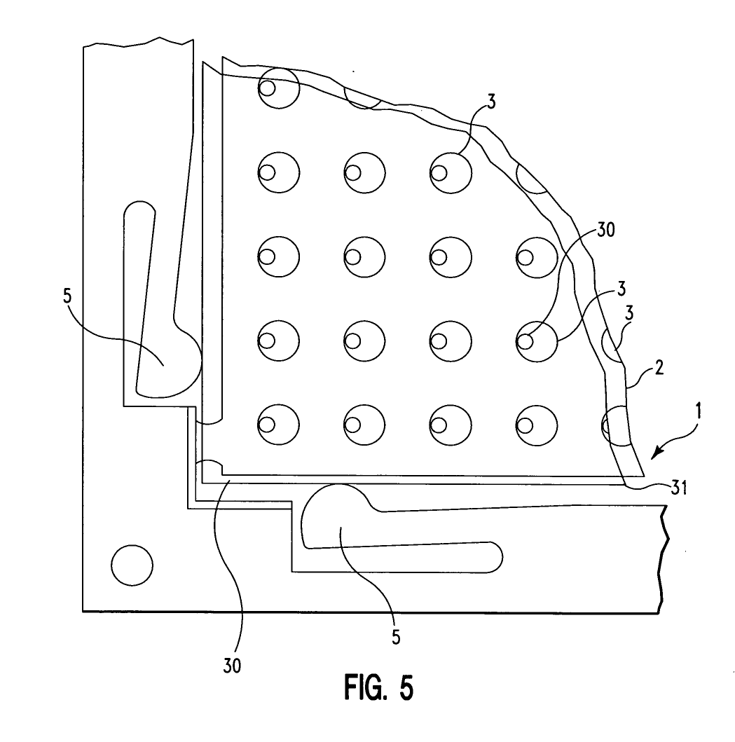

Referring to FIG. 4 there is shown a portion of the inspection master 30 inserted into the LGA socket 1. In this embodiment the inspection target feature 32 is a solid circle having a diameter smaller than the size of the socket electrical contact 3. In a typical application the target feature 32 would have a diameter of approximately 0.008 inches and the socket electrical contact 3 would have a diameter of approximately 0.020 inches. A typical array grid spacing is approximately 0.040 inches.

FIG. 4 shows a conventional spring finger 5 which engages a chip carrier on each edge to position the chip carrier with respect to the socket connections. In FIG. 4 we see the transparent block 31 inserted in place of a chip carrier. This example shows good alignment between the transparent block 31 and socket 1 as indicated by the concentricity between the inspection target features 32 and the socket electrical contacts 3. Therefore a chip carrier having a similar perimeter size and contact pad array would have good electrical contact with this socket.

In contrast, FIG. 5 shows an example of poor alignment between the inspection target features 32 on the transparent block 31 and the socket electrical contacts 3. The offset between the inspection master target feature 32 and the LGA socket contact 3 both illustrates and quantifies the positional error of the LGA socket from its intended design position. In this example a weak or damaged spring fingers 5 has resulted in a misalignment between the target features 32 and socket electrical contacts 3 of approximately 0.006 inches. This is readily determined since in this example the nominal socket electrical contact 3 is 0.020 inches and the target feature 32 is 0.008 inches. Since the example in FIG. 5 shows the target feature 32 is tangent to the electrical contact, the displacement is therefore 0.006 inches.

This example illustrates how the degree of misalignment between the inspection master 30 and socket 1 can be readily quantified, and therefore, the amount of misalignment between the socket and a chip carrier can be predicted as well. The inspection master 30 allows identification of the contact location accuracy. This allows defective LGA sockets to be identified and screened out prior to use on product.

It has been observed that in molded frame sockets the spring fingers 5 do not always have the same spring rate within one socket. In addition there are also variations across production runs, i.e., lot to lot variations. The flow of molten plastic, which usually contains powdered filler materials, can lead to variations in grain and density of the plastic spring fingers which can affect their spring rate and physical uniformity. The inspection master 30 allows the measurement of the LGA socket under actual use conditions. The inspection master also provides a characterization of the location error which can be used to take corrective action on subsequent socket manufacture.

As illustrated in the preceding examples the inspection master can be used in multiple ways. It can be used as a quick visual quality check on socket/contact positional accuracy. It can be used in conjunction with an automated optical inspection tool. It can be used in conjunction with an optical comparator. It can also be used for in-line socket manufacturing process control and improvements.

It has also been observed that in molded socket contact carriers the grid contact spacing is not always uniform across the array with the socket. The inspection master provides a quick and easy measurement and characterization of any distortion. This characterization of the magnitude and geometry of any positional error could form an analysis including a map of the array distortion. With a detailed analysis and picture of the location and magnitude of any deviation in positional accuracy of the socket contacts, the socket manufacturer can take corrective action on subsequent socket fabrication by adjusting molding process materials and parameters. It may also be possible to use the analysis to adjust the positional accuracy of a defective socket. An example would be adjusting a damaged spring.

It will be apparent to those skilled in the art having regard to this disclosure that other modifications of this invention beyond those embodiments specifically described here may be made without departing from the spirit of the invention. Accordingly, such modifications are considered to be within the scope of the invention as limited solely by the appended claims.

1. A socket measurement apparatus comprising:
a transparent block having inspection target features located on a surface of said transparent block, said inspection target features provided on an array, said array matching a socket electrical design contact array; and
said block having a perimeter size tailored to a chip carrier perimeter size to be socket tested.

2. The socket measurement apparatus of claim 1 wherein said perimeter size is tailored to a nominal chip carrier perimeter size.

3. The socket measurement apparatus of claim 1 wherein said perimeter size is tailored to a minimum chip carrier perimeter size.

4. The socket measurement apparatus of claim 1 wherein said perimeter size is tailored to a maximum chip carrier perimeter size.

5. (canceled)

6. (canceled)

7. The socket measurement apparatus of claim 6 wherein said inspection target features have a point geometry.

8. The socket measurement apparatus of claim 6 wherein said inspection target features have a circular geometry.

9. The socket measurement apparatus of claim 6 wherein said inspection target features have a cross geometry.

10. The socket measurement apparatus of claim 6 wherein said inspection target features have a square geometry.

11. The socket measurement apparatus of claim 1 wherein said transparent block is made from a material selected from the group consisting of lexan, Plexiglas, glass, quartz, acrylic, Lucite and crystal polystyrene.

12. The socket measurement apparatus of claim 1 further comprising a socket with edge centering means, said transparent block inserted in said socket.

13. A method for determining the amount of positional error in a socket, comprising the steps of:
providing a socket having an electrical contact array, said socket having edge centering means;
providing a transparent block having inspection target features located on a surface of said transparent block, said inspection target features provided on an array, said array matching said socket electrical contact army design nominal;
inserting said transparent block in said socket;
comparing the position of said inspection target features to the position of said electrical contact array, thereby determining the amount of positional error in said socket electrical contact array.

14. The method of claim 13 wherein said transparent block has a perimeter size tailored to a chip carrier perimeter size to be socket tested.

15. The method of claim 13 wherein said perimeter size is tailored to a nominal chip carrier perimeter size.

16. The method of claim 13 wherein said perimeter size is tailored to a minimum chip carrier perimeter size.

17. The method of claim 13 wherein said perimeter size is tailored to a maximum chip carrier perimeter size.

18. A method for determining characteristics of a socket to correct socket positional error comprising the steps of:
providing a socket having an electrical contact array, said socket having edge centering means;
providing a transparent block having inspection target features located on a surface of said transparent block, said inspection target features provided on an array, said array matching said socket electrical contact array design nominal;
inserting said transparent block in said socket;
comparing the position of said inspection target features to the position of said electrical contact array, thereby determining the magnitude and location of positional error in said socket electrical contact array; and
generating an analysis of said positional error for correcting said positional error.

19. The method of claim 18 wherein said analysis is used to repair a defective socket.

20. The method of claim 18 wherein said analysis is used to adjust said socket fabrication process.
